(19) United States
(12) Patent Application Publication
(10) Pub. No.: US 2003/0110481 A1
(43) Pub. Date: Jun. 12, 2003

(54) Program tuning method

(76) Inventors: Kiyomi Wada, Yokohama (JP); Makoto Satoh, Machida (JP); Takayoshi Iitsuka, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/196,167

(22) Filed: Jul. 17, 2002

(30) Foreign Application Priority Data
Dec. 6, 2001 (JP) 2001-372620

(51) Int. Cl. G06F 9/45

(52) U.S. Cl. 717/158; 717/149

(57) ABSTRACT

A plurality of compiler directives are applied one by one to each program portion of a computer program including the program portions to be converted by the compiler directive to execute each program portion. An execution time of each program portion for each compiler directive is measured as a result of the execution. A compiler directive having a shortest execution time for each program portion is detected on the basis of the measured results. Each of the detected compiler directives is inserted into just before a relevant program portion to produce a program.

### BACKGROUND OF THE INVENTION

The present invention relates to compiler technique for computer programs, and more particularly to the technique suitable for effective tuning of computer programs including program portions to be converted by compiler directives.

Heretofore, technique for deciding the optimization method which is more satisfactory for a given program is disclosed in JP-A-06-274350, for example. In JP-A-06-274350, the same optimization method is applied to the whole programs and the genetic algorithm is used to select a compile option with which the execution time of the whole programs is shortest. However, this technique has a problem that a most advantageous compile option cannot be selected when the optimization method is different for each program portion.

Further, conventional technique for tuning the performance of program portions requiring time is described in, for example, Mitsuhisa Sato et al., “Automatic Adaptive Parallel Program Performance Optimization Tool TEA EXPERT”, Report 72-3 of HPC Study Meeting, Information Processing Society of Japan, August 1998, pp.13-18. In this technique, a compiler directive with parameters is previously inserted into a specific position of a program and the parameters are varied automatically to execute the program, so that an optimum parameter set is decided.

In this technique, however, since the compiler directive with performance parameters must be inserted into the program by hand and a time measurement section must be designated, there is a problem that burden on a user is increased. The compiler directive with performance parameters is a compiler directive, for example, as follows:

“#pragma unroll (N_UNROLL)”

where “unroll” designates the unrolling of loop of the program loop and “N_UNROLL” is a performance parameter representing the number of unrolling operations for the unrolling of loop.

As described above, heretofore, when the optimization method is different for each program portion, the most advantageous compile option cannot be selected or the compiler directive with performance parameters must be inserted into the program by hand and the timing section must be designated.

### SUMMARY OF THE INVENTION

It is an object of the present invention to provide program tuning technique capable of executing programs at a high-speed.

It is another object of the present invention to provide program tuning technique capable of lightening burden on a user required for optimization of programs.

It is still another object of the present invention to provide program tuning technique capable of reducing the number of times of trials required to decide the optimization method.

In order to achieve the above objects, according to the present invention, when a computer program (e.g., 120 of FIG. 2) including program portions (e.g., L1, L2 of FIG. 2) to be converted by compiler directives is turned, a compiler directive (e.g., 123 of FIG. 3) is applied to each program portion is executed for each of a plurality of compiler directives. An execution time of each program portion for each compiler directive is measured. A compiler directive having a shortest execution time for each program portion is detected on the basis of the measured results. Each of the detected compiler directives is inserted into just before a relevant program portion to produce a program (e.g., 129 of FIG. 9).

Further, a set of a plurality of compiler directives may be applied to each program portion to execute each program portion. An execution time thereof is measured and a combination of compiler directives having a shortest execution time for each program portion is detected. The combination of compiler directives is inserted into just before each program portion to produce a program. The application and the execution of a compiler directive to each program portion, the measurement of the execution time and the detection of a compiler directive having the shortest execution time are made by the number of kinds of compiler directives and performance parameters or the number of kinds of compiler directives and combinations of performance parameters.

According to the present invention, since an optimization method can be selected for each program portion, the program can be executed at high speed even if an effective optimization method is different for each program portion. Further, since a user is not required to insert a compiler directive with parameter into the program, the burden on the user required for optimization of the program can be reduced. In addition, the number of times of trials for detecting the optimization method for each program portion can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically illustrating an embodiment of a program tuning system according to the present invention;

FIG. 2 is a diagram explaining a definite example of a source program in FIG. 1;

FIG. 3 is a diagram explaining definite examples of option information files in FIG. 1;

FIG. 4 is a diagram explaining a definite example of an option information generalization file in FIG. 1;

FIG. 5 is a diagram explaining a definite example of an evaluation program in FIG. 1;

FIG. 6 is a diagram explaining a definite example of an evaluation option information file in FIG. 1;

FIG. 7 is a diagram explaining a definite example of an execution time information file in FIG. 1;

FIG. 8 is a diagram explaining a definite example of an execution time information generalization file in FIG. 1;

FIG. 9 is a diagram explaining a definite example of a program with compiler directive in FIG. 1;

FIGS. 10A to 10C are diagrams explaining data structure examples in the option information generalization file of FIG. 1;

FIGS. 11A to 11C are diagrams explaining data structure examples in the option information file of FIG. 1;

FIGS. 12A to 12C are diagrams explaining data structure examples in the execution time information generalization file of FIG. 1;

FIGS. 13A to 13C are diagrams explaining data structure examples in the execution time information file of FIG. 1;

FIGS. 14A to 14C are diagrams explaining data structure examples in the evaluation option information file of FIG. 1;

FIGS. 15A to 15F are diagrams explaining definite examples of internal information arrays upon data processing of an optimum option decision unit in FIG. 1;

FIG. 16 is a flowchart showing an operation example of a control program in FIG. 1;

FIGS. 17A to 17B are diagram explaining structure examples of option information tables in FIG. 1;

FIG. 18 is a flowchart showing a processing operation example of an option information acquisition unit in FIG. 1;

FIG. 19 is a flowchart showing a processing operation example of a compiler directive generation unit in FIG. 1;

FIG. 20 is a flowchart showing a processing operation example of an execution time acquisition code generation unit in FIG. 1;

FIGS. 21A to 21D are diagrams explaining structure examples of execution time acquisition codes produced in the execution time acquisition code generation unit in FIG. 1;

FIGS. 22A to 22F are diagrams explaining information array examples upon data processing of the optimum option decision unit in FIG. 1;

FIG. 23 is a flowchart showing a processing operation example of the optimization option decision unit in FIG. 1;

FIG. 24 is a flowchart showing a processing operation example of a compiler directive insertion unit of an optimum program generation tool in FIG. 1;

FIGS. 25A to 25B are diagrams explaining structure examples of user interfaces in an option designation unit of FIG. 1; and

FIG. 26 is a diagram explaining another embodiment of a program with compiler directives.

### DESCRIPTIN OF THE EMBODIMENTS

Embodiments of the present invention are now described in detail with reference to the accompanying drawings.

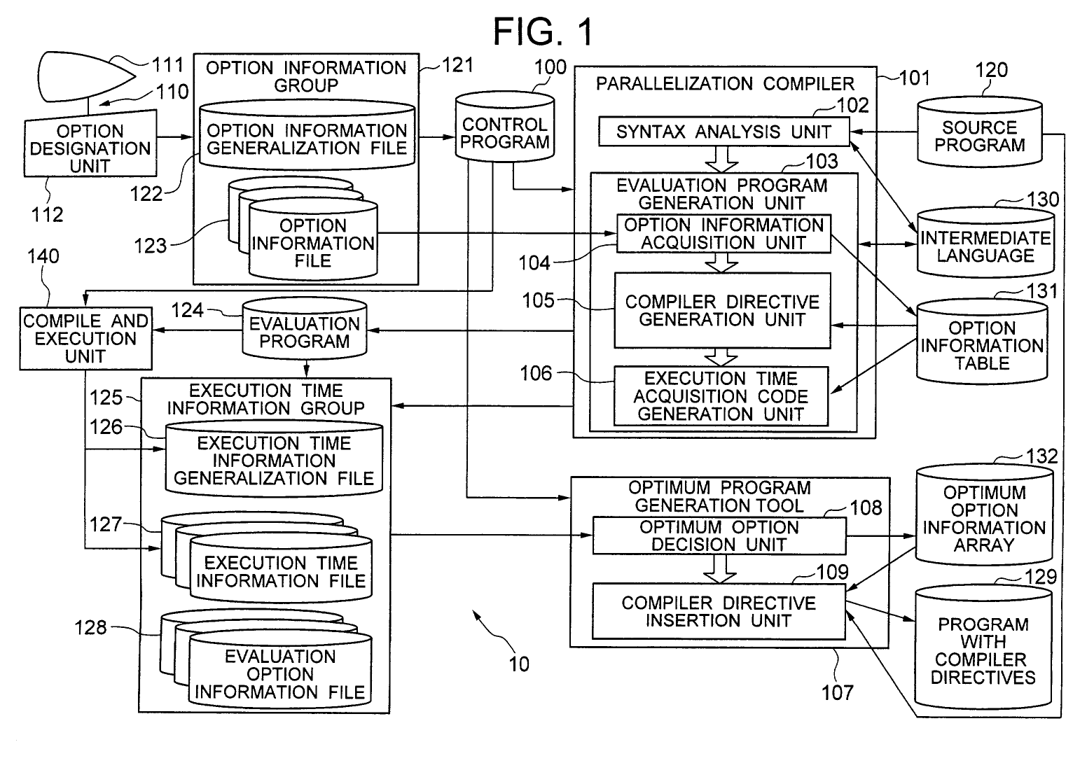

FIG. 1 is a block diagram schematically illustrating an embodiment of a program tuning system according to the present invention.

The program tuning technique for a computer program including loop processing is now described.

The system 10 shown in FIG. 1 includes an information processing apparatus provided with an output unit such as, for example, CRT or LCD, an input unit such as, for example, keyboard and mouse, an external storage unit such as HDD, a CPU, a main memory and an input/output interface to perform computer processing, an optical disk driver for reading out programs and data recorded in an optical disk such as CD-ROM and a communication unit such as a LAN card. For example, the programs and the data stored in the optical disk are loaded in the external storage unit through the optical disk driver by means of the information processing unit and then read in the main memory from the external storage unit to be processed by the CPU so that constituent portions are loaded to thereby perform the program tuning according to the present invention.

Functionally, the program tuning system 10 of the embodiment is composed of an option designation unit 110, a control program 100, a parallelization compiler 101, an optimum program generation tool 107, a compile and execution unit 140.

The parallelization compiler 101 is composed of a syntax analysis unit 102 and an evaluation program generation unit 103. Further, the evaluation program generation unit 103 is composed of an option information acquisition unit 104, a compiler directive generation unit 105 and an execution time acquisition code generation unit 106.

Moreover, the optimum program generation tool 107 is composed of an optimum option decision unit 108 and a compiler directive generation unit 109.

With such configuration, in the program tuning system of the embodiment, when a computer program including program portions to be converted by an option (compiler directive) is tuned automatically, one of a plurality of compiler directives is taken out to be inserted into just before each of the program portions by the evaluation program generation unit 103. An evaluation program 124 is generated having program portions into which a code for measuring an execution time of each program portion into which the compiler directive was inserted is inserted. The evaluation program 124 is compiled to be executed by the compile and execution unit 140 so that the execution time of each program portion in the evaluation program is measured and stored in the memory unit (execution time information group 125). After the generation and the execution of the evaluation program are repeated by the number of the plurality of compiler directives, the optimum program generation tool 107 detects a compiler directive with which the execution time of the program portion is shortest for each program on the basis of the measured results of the execution time of each program portion. Each of the detected compiler directives is inserted into just before the relevant program portion to produce the program 129 with compiler directives. Application and execution of the compiler directive to each program portion, measurement of the execution time and detection of the compiler directive with which the execution time is shortest are made by the number of kinds of the compiler directives and performance parameters.

Alternatively, when the compiler directive is applied to each program portion, a set of compiler directives are applied thereto and executed so that execution time thereof is measured and a combination of compiler directives with which the execution time of the program portion is shortest is detected for each program portion. The combination of the compiler directives thus detected is inserted into just before each program portion to produce the program. In this case, application and execution of the compiler directive to each program portion, measurement of the execution time thereof and detection of the compiler directive with which the execution time is shortest are made by the number of combinations of kinds of the compiler directives and sets of performance parameters.

Details of the respective units are now described. The option designation unit 110 designates an option (compiler directive) by user's operation of an input unit 112 such as, for example, a keyboard to thereby produce an option information group 121. The option information group 121 includes an option information generalization file 122 and a plurality of option information files 123 described later.

The syntax analysis unit 102 in the parallelization compiler 101 is supplied with a source program 120 and produces an intermediate language 130.

The option information acquisition unit 104 in the evaluation program generation unit 103 is supplied with the option information file 123 in the option information group 121 and the intermediate language 130 and produces an option information table 131 as described later and an evaluation option information file 128 in the execution time information group 125.

The compiler directive generation unit 105 and the execution time acquisition code generation unit 106 in the evaluation program generation unit 103 are supplied with the intermediate language 130 and the option information table 131 and produces the compiler directive and the evaluation program with execution time acquisition code.

The evaluation program 124 is compiled and executed by the compile and execution unit 140 to measure the execution time of each program portion for each compiler directive. The measured results are stored as an execution time information generalization file 126 and an execution time information file 127 in the execution time information group 125.

The optimum option decision unit 108 in the optimum program generation tool 107 is supplied with the execution time information group 125 and produces an optimum option information array 132.

The compiler directive insertion unit 109 in the optimum program generation tool 107 is supplied with the source program 120 and the optimum option information array 132 and produces the program 129 with compiler directives.

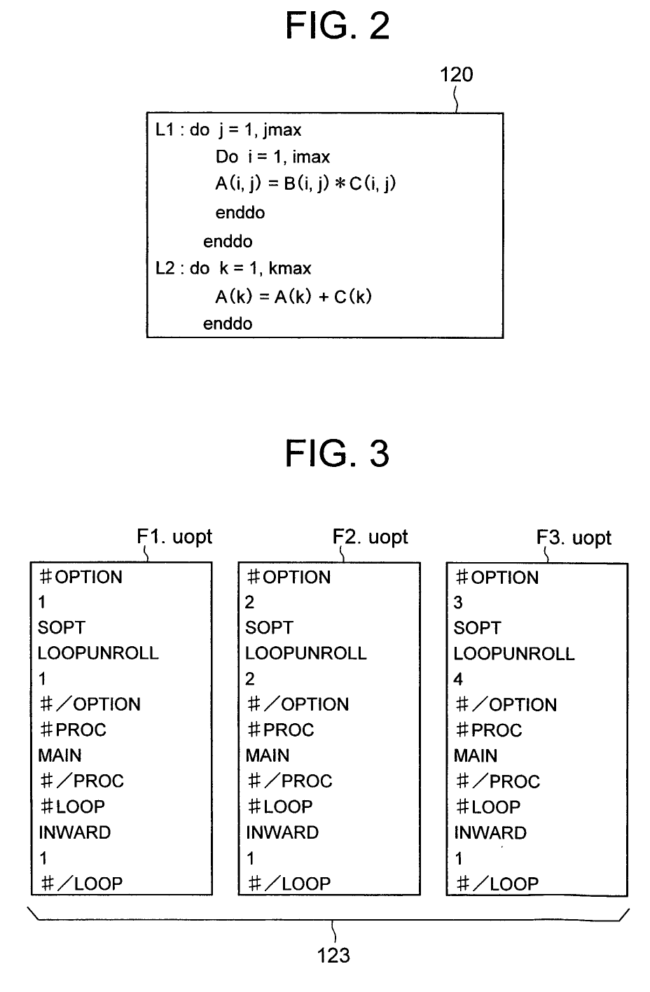

The program tuning operation performed by the system 10 illustrated in FIG. 1 is now described with reference to definite examples shown in FIGS. 2 to 9.

FIG. 2 is a diagram explaining a definite example of a source program 120 to be optimized.

The source program 120 of this example has a double loop and a single loop. “L1” is a line number of an outer loop of the double loop and “L2” is a line number of the single loop.

FIG. 3 is a diagram explaining definite examples of the option information files 123 for applying the option to the source program individually.

The option information files 123 of this example include the option information files “F1.uopt”, “F2.uopt” and “F3.uopt” which hold information for preparing first, second and third compiler directives, respectively. In the option information file “F1.uopt”, the number of unrolling operations “1” (loop is not unrolled) for unrolling of loop “LOOPUNROLL” is applied to an outermost loop of the program of interest. In the option information file “F2.uopt”, the number of unrolling operations “2” for the unrolling of loop “LOOPUNROLL” is applied to an outermost loop. In the option information file “F3.uopt”, the number of unrolling operations “4” for the unrolling of loop “LOOPUNROLL” is applied to an outermost loop.

The operation of reading the option designated by the user designation unit 110 of FIG. 1 into the option information file 301 is made by hand or automatically.

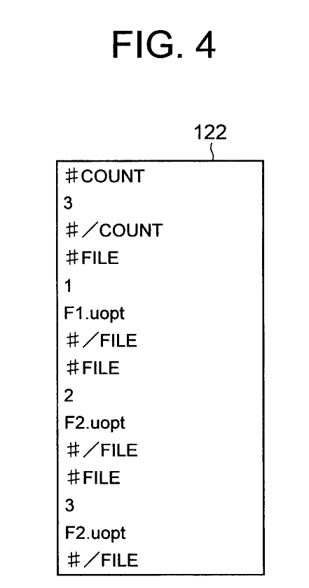

FIG. 4 shows a definite example of the option information generalization file 122 for generalizing a plurality of option information files shown in FIG. 3.

In the option information generalization file 122 of this example, the number of times of trials COUNT is “3” equal to the number of the option information files shown in FIG. 3 and the option information files are “F1.uopt”, “F2.uopt” and “F3.uopt”. The operation for reading the option designated by the user designation unit 110 of FIG. 1 into the option information generalization file 122 is made by hand or automatically. The evaluation program generation unit 103 can refer to the option information generalization file 122 to thereby understand how the option information files are applied.

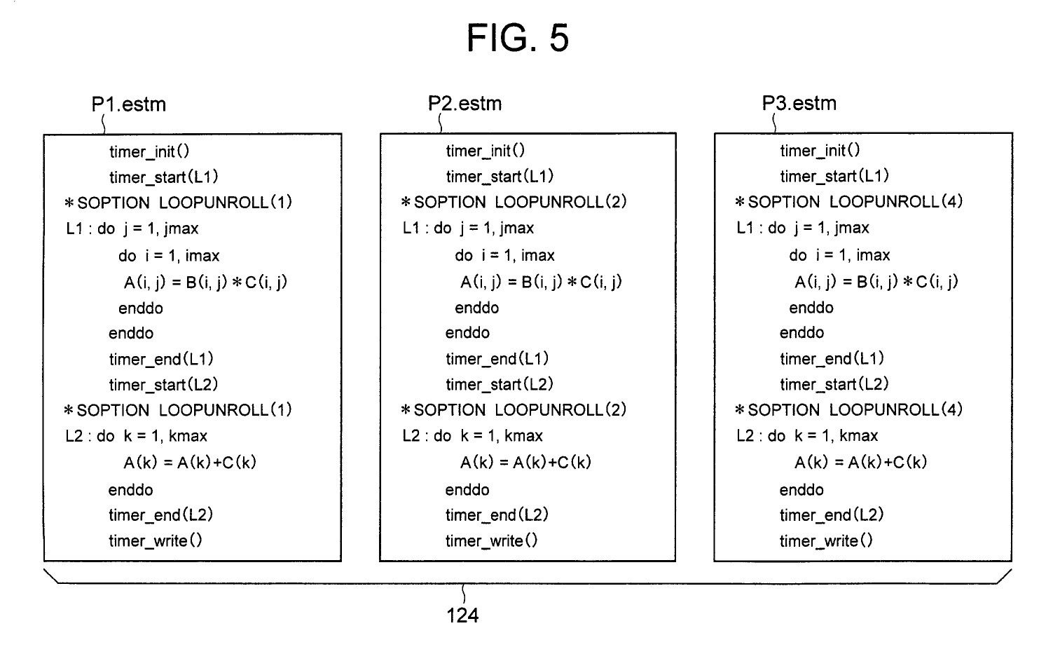

FIG. 5 is a diagram explaining definite examples of evaluation programs 124 to which the option is applied individually.

In this example, “P1.estm”, “P2.estm” and “P3.estm” are illustrated as the evaluation programs 124. The option information files “F1.uopt”, “F2.uopt” and “F3.uopt” of the option information files 123 are inputted to produce the evaluation programs “P1.estm”, “P2.estm” and “P3.estm” under control by the control program 100 of FIG. 1.

More particularly, the option information acquisition unit 104 in the evaluation program generation unit 103 converts the option information files “F1.uopt”, “F2.uopt” and “F3.uopt” of the option information files 123 into the option information table 131 which is the internal expression in the compile and connects or links an option table to a loop table for the outermost loop of the procedure “MAIN”.

The compiler directive generation unit 105 of FIG. 1 produces the evaluation programs “P1.estm”, “P2.estm” and “P3.estm” in which first, second and third compiler directives “*SOPTION LOOPUNROLL(1), (2) and (4)” are inserted into just before loops starting from line numbers “L1” and “L2” in which the option table is linked to the loop table, respectively.

Further, the execution time acquisition code generation unit 106 of FIG. 1 inserts an initialization code “timer init” into the head of the program, start time acquisition codes “timer start” into entrances of the loops starting from the line numbers “L1” and “L2” in which the option table is linked to the loop table, end time acquisition codes “timer end” into exits of the loops starting from the line numbers “L1” and “L2” in which the option table is linked to the loop table, and an execution time information file output code “timer write” into the end of the program.

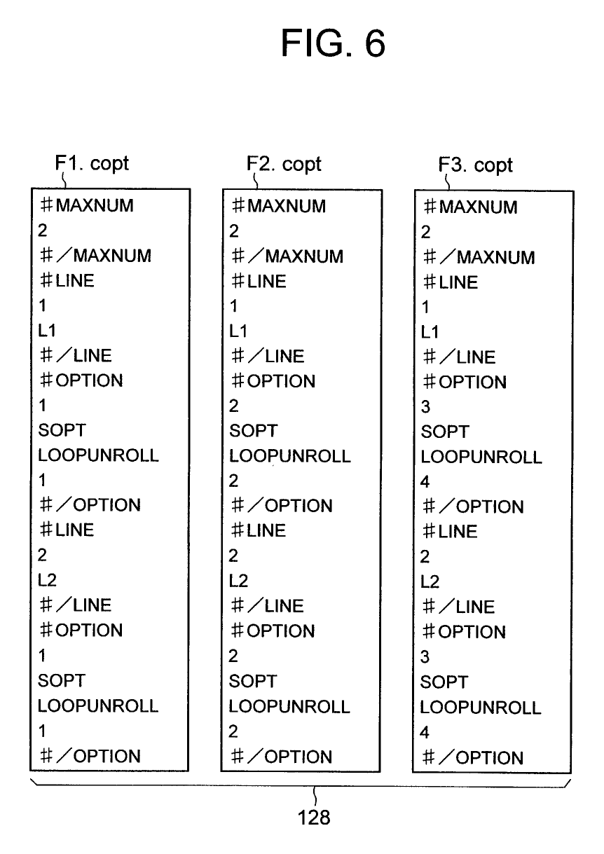

FIG. 6 is a diagram explaining definite examples of evaluation option information files 128 used when the evaluation programs 124 shown in FIG. 5 are prepared.

The option information acquisition unit 104 in the evaluation program generation unit 103 of FIG. 1 converts the option information files “F1.uopt”, “F2.uopt” and “F3.uopt” of the option information files 123 into the option information table 131 which is the internal expression in the compile. The unit 104 detects the loop table for the outermost loop of the procedure “MAIN” to thereby write the option information for each loop into evaluation option information file “F1.copt” or “F2.copt” or “F3.copt”.

The evaluation option information file “F1.copt” includes the maximum value “MAXNUM” of the consecutive number for the line information being “2” equal to the number of loops of the program 120 of interest, the line number for the line information “1” being “L1”, the option information “1” being the unrolling of loop “1”, the line number for the line information “2” being “L2” and the option information “2” being the unrolling of loop “1”.

Similarly, the evaluation option information file “F2.copt” includes the unrolling of loop “2” for line number “L1” and the unrolling of loop “2” for line number “L2”. Further, the evaluation option information file “F3.copt” includes the unrolling of loop “4” for line number “L1” and the unrolling of loop “4” for line number “L2”.

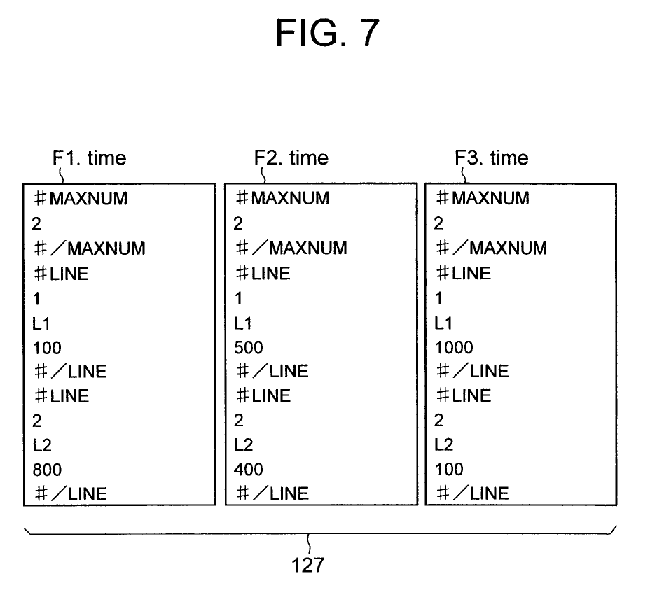

FIG. 7 is a diagram explaining definite examples of execution time information files 127 in which the execution times for respective loops obtained by execution of the evaluation programs shown in FIG. 5 are written.

In the execution time information file “F1.time” of the execution time information files 127 of this example, the maximum value “MAXNUM” of the consecutive number for the line information is “2” equal to the number of loops of the program of interest, and the line number for the line information “1” is “L1”, the execution time of the line number “L1” being “1000 seconds”, the line number for the line information “2” being “L2”, the execution time of the line number “L2” being “100 seconds”.

Similarly, the execution time information file “F2.time” includes the execution time of the line number “L1” being “500 seconds” and the execution time of the line number “L2” being “400 seconds”. Further, the execution time information file “F3.time” includes the execution time of the line number “L1” being “1000 seconds” and the execution time of the line number “L2” being “100 seconds”.

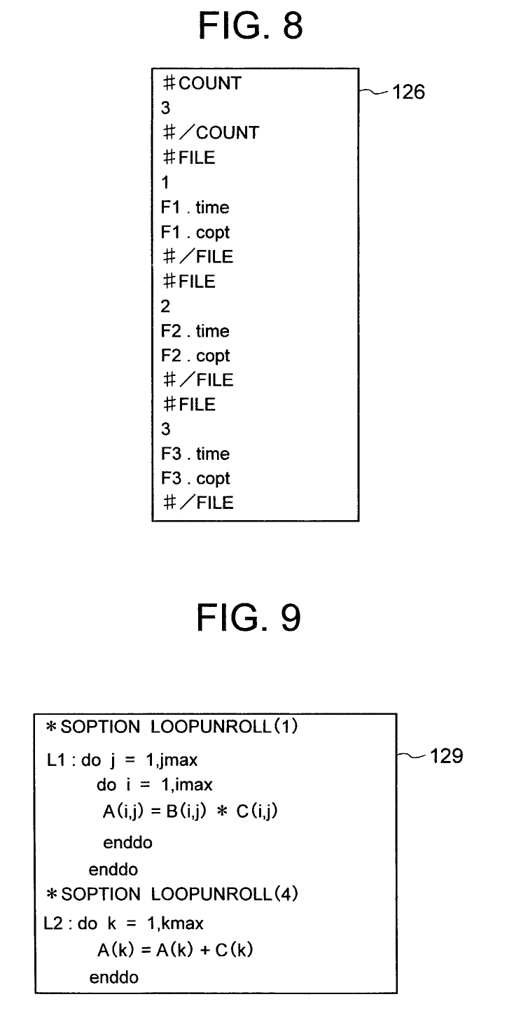

FIG. 8 is a diagram explaining a definite example of the execution time information generalization file 126 in which the files required for execution of the plurality of evaluation programs “P1.estm”, “P2.estm” and “P3.estm” shown in FIG. 5 are arranged.

In the execution time information generalization file 126 of this example, the number of times of trials COUNT is “3” equal to the number of evaluation programs and the execution time information files 127 are “F1.time”, “F2.time” and “F3.time”, the evaluation option information files 128 being “F1.copt”, “F2.copt” and “F3.copt”. The compile and execution unit 140 can refer to the execution time information generalization file 126 to understand all of files required for execution of the evaluation programs.

FIG. 9 is a diagram explaining a definite example of the program 129 with compiler directives obtained finally.

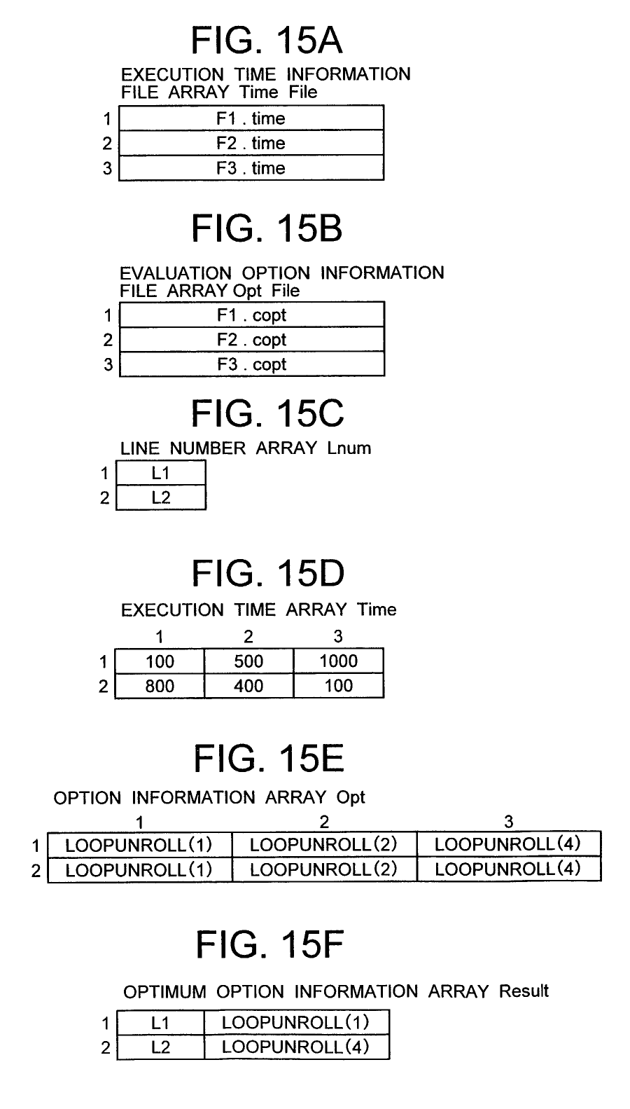

The program 129 with compiler directives of this example is an optimized program of the source program 120 shown in FIG. 2. The optimum option of the line number “L1” is the unrolling of loop “1” and the optimum option of the line number “L2” is the unrolling of loop “4” from the execution time information file 127 (that is, optimum option array “Result” of FIG. 15F) shown in FIG. 7. Accordingly, the compiler directive insertion unit 109 of FIG. 1 inserts the compiler directive “*SOPTION LOOPUNROLL(1)” for the unrolling of loop “1” (loop is not unrolled) into the loop of the line number “L1” and the compiler directive “*SOPTION LOOPUNROLL(4)” for the unrolling of loop “4” into the loop of the line number “L2” as shown in FIG. 9.

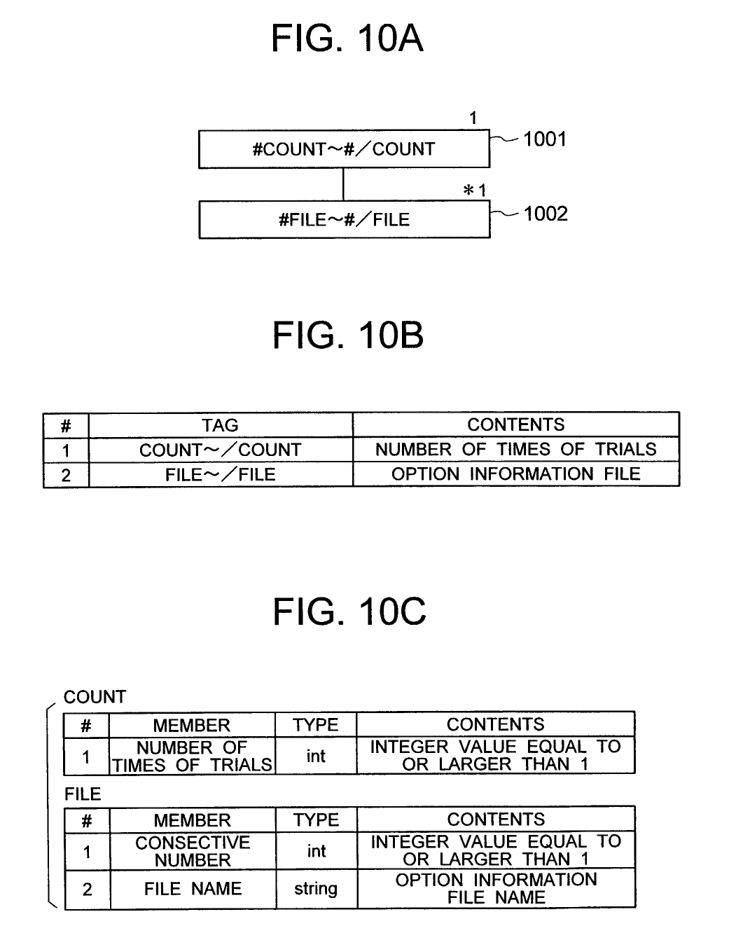

Referring now to FIGS. 10 to 14, the specification of the option information generalization file 122, the option information file 123, the execution time information generalization file 126, the execution time information file 127 and the evaluation option information file 128 produced by the above-mentioned processing units is described.

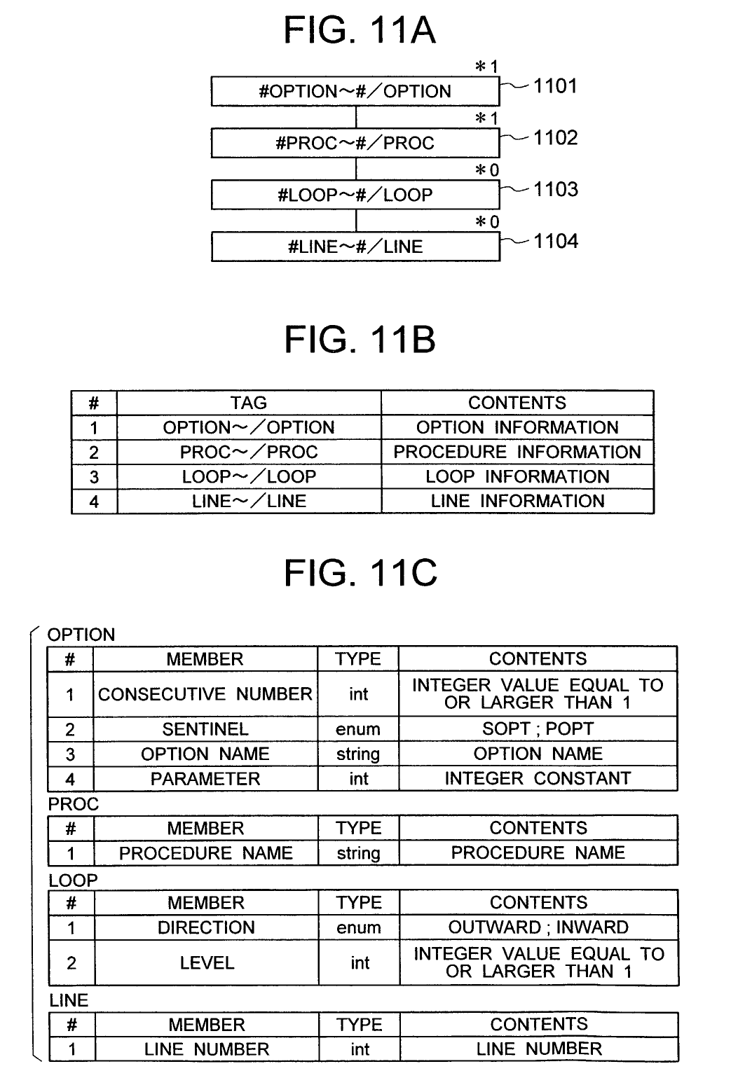

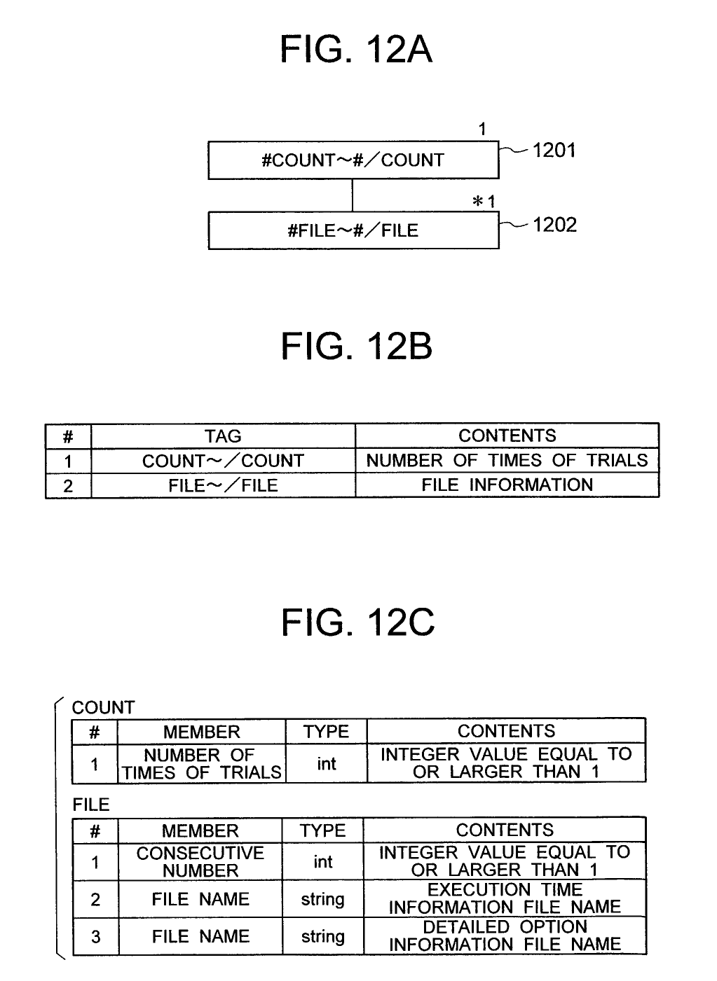

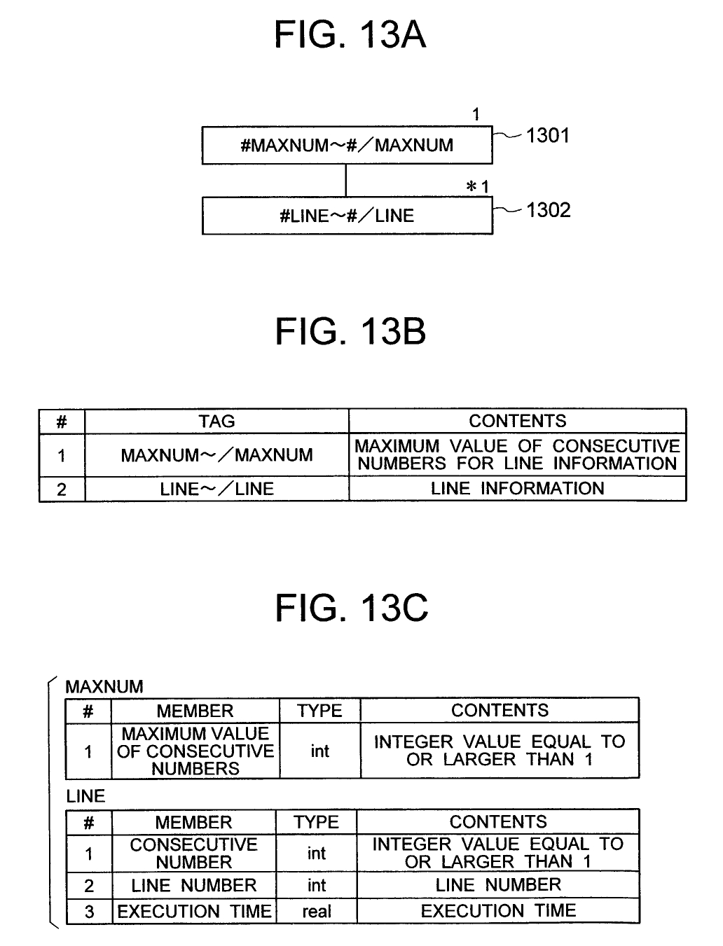

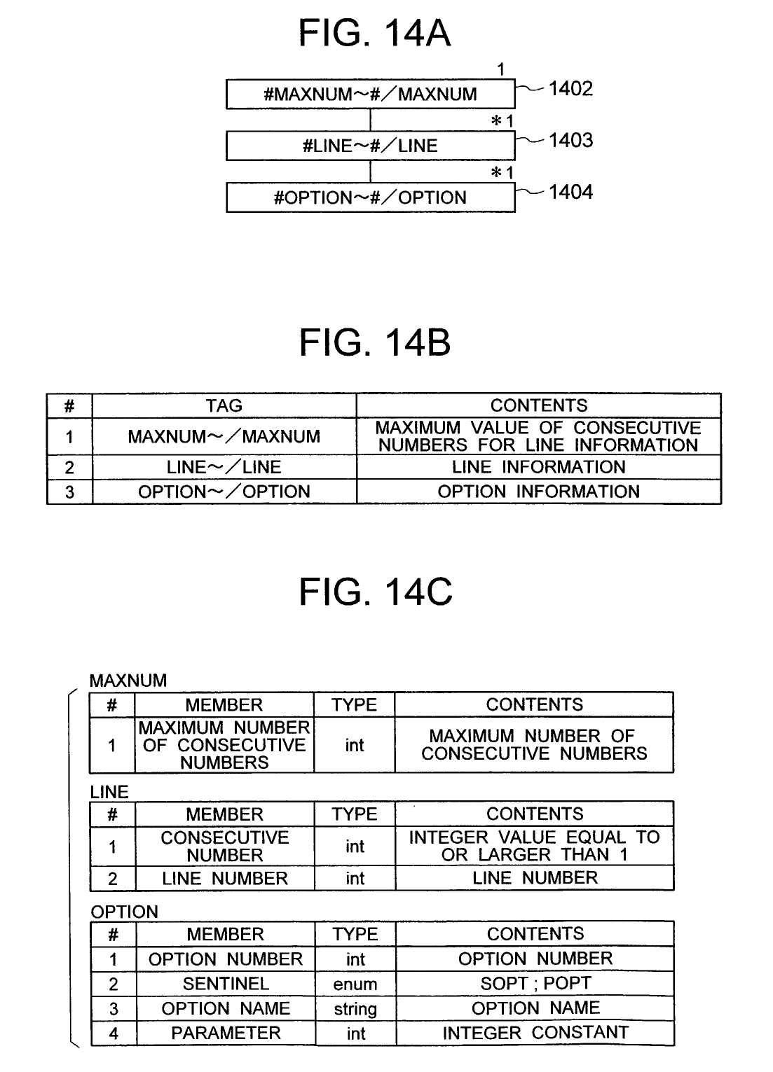

FIGS. 10A to 10C are diagrams explaining data structure examples in the option information generalization file 122 of FIG. 1, FIGS. 11A to 11C are diagrams explaining data structure examples in the option information file 123 of FIG. 1, FIGS. 12A to 12C are diagrams explaining data structure examples in the execution time information generalization file 126 of FIG. 1, FIGS. 13A to 13C are diagrams explaining data structure examples in the execution time information file 127 of FIG. 1, and FIGS. 14A to 14C are diagrams explaining data structure examples in the evaluation option information file 128 of FIG. 1.

Data in the option information generalization file 122, the option information file 123, the execution time information generalization file 126, the execution time information file 127 and the evaluation option information file 128 shown in FIGS. 10 to 14 are described structurally by means of tags.

FIG. 10A shows a tag structure of the option information generalization file 122, FIG. 10B shows a list of tags and FIG. 10C shows a format of tags.

As shown in FIG. 10A, lower tags (“FILE˜/FILE”) are arranged next to upper tags (“COUNT˜/COUNT”). Each tag starts with “#” and ends with line feed or carriage return. In FIG. 10A, “1” represents the number of repetitions equal to one time and “*1” represents the number of repetitions equal to or larger than one time. As shown in FIG. 10B, “COUNT” represents “the number of times of trials” (that is, the number of evaluation programs applied to the program of interest) and “FILE” represents the option information file.

FILEs 1002 representing the option information file are equal in number to the number of COUNTs 1001 representing the number of times of trials. Thus, the option information generalization file 122 shown in FIG. 4 includes COUNT 1001 representing the number of times of trials and FILEs 1002 representing the option information files.

FIGS. 11A to 11C show specification of the option information file 123 and FIG. 11A shows a tag structure. Lower tags are arranged next to upper tags. Each tag starts with “#” and ends with line feed. “*0” represents the number of repetitions equal to or larger than 0 time and “*1” represents the number of repetitions equal to or larger than one time.

The option information file 123 shown in FIG. 3 includes OPTION 1101 representing the option information, procedure information PROC 1102 representing the option insertion position in the program, loop information LOOP 1103 and line information LINE 1104.

Any of the loop information LOOP 1103 and the line information LINE 1104 is designated. The loop information LOOP 1103 can be designated in loop level and the line information LINE 1104 can be designated in line unit.

FIGS. 12A to 12C show specification of the execution time information generalization file 126 and FIG. 12A shows a tag structure. Lower tags are arranged next to upper tags. Each tag starts with # and ends with line feed. “1” represents the number of repetitions equal to one time and “*1” represents the number of repetitions equal to or larger than one time.

FILEs 1202 representing the execution time information file 127 and the evaluation option information file 128 are equal in number to the number of COUNTs 1201 representing the number of times of trials.

The execution time information generalization file 126 of FIG. 8 includes COUNT 1201 representing the number of times of trials and FILEs 1202 representing the execution time information file 127 and the evaluation option information file 128 and has the execution time information files and the evaluation option information files (FILEs 1202) equal in number to the number of COUNTs 1201 representing the number of times of trials.

FIGS. 13A to 13C show specification of the execution time information file 127 and FIG. 13A show a tag structure. Lower tags are arranged next to upper tags. Each tag starts with # and ends with line feed. “1” represents the number of repetitions equal to one time and “*1” represents the number of repetitions equal to or larger than one time. LINEs 1302 representing the execution time are equal in number to the number of MAXNUM 1301 representing the maximum value of the consecutive number.

The execution time information file 127 of FIG. 7 includes MAXNUM 1301 representing the maximum value of the consecutive number for the line information and LINEs 1302 representing the line information. The line information LINE 1302 includes the loop start line number in which the option information OPTION 1101 is inserted and the loop execution time.

FIGS. 14A to 14C show specifications of the evaluation option information file 128 and FIG. 14A shows a tag structure. Lower tags are arranged next to upper tags. Each tag starts with # and ends with line feed. “1” represents the number of repetitions equal to one time and “*1” represents the number of repetitions equal to or large than one time.

LINEs 1403 representing the evaluation option information file 128 are equal in number to the number of MAXNUMs 1402 representing the maximum value of the consecutive number. The evaluation option information file 128 of FIG. 6 includes MAXNUM 1402 representing the maximum value of the consecutive number for the line information, LINEs 1403 representing the line information in which the option is inserted and OPTIONs 1404 representing the option information.

FIGS. 15A to 15F are diagrams explaining definite examples of internal information arrays upon data processing of the optimum option decision unit in FIG. 1.

FIG. 15A shows an example of an execution time information file array “TimeFile”. Suffixes “1” to “3” of the array represent the time of trial and each element of the array is an execution time information file name obtained in each trial. The array is prepared by reading in the execution time information generalization file 126 by the optimum option decision unit 108 of FIG. 1.

FIG. 15B shows an example of the evaluation option information file array “OptFile”. Suffixes “1” to “3” of the array represent the time of trial and each element of the array is an evaluation option information file name used in each trial. The array is prepared by reading in the execution time information generalization file 126 by the optimum option decision unit 108 of FIG. 1.

FIG. 15C shows an example of a line number array “Lnum”. Suffixes “1” to “2” of the array represent the consecutive number for the line information and elements of the array are the line numbers “L1” and “L2” for the loops designating the compile option. The array is prepared by reading in the line information of the execution time information files “F1.time”, “F2.time” and “F3.time” by the optimum option decision unit 108 of FIG. 1.

FIG. 15D shows an example of an execution time array “Time”. First suffixes “1” to “2” of the array represent the consecutive number for the line information and second suffixes “1” to “3” of the array represent the time of trial. Elements of the array are the execution times for respective loops obtained by trials. The array is prepared by reading in the line information of the execution time information files “F1.time”, “F2.time” and “F3.time” by the optimum option decision unit 108.

FIG. 15E shows an example of an option array. First suffixes “1” to “2” of the array represent the consecutive number for the line information and second suffixes “1” to “3” of the array represent the time of trial. Elements of the array are options for respective loops used in trials.

Accordingly, in the first trial, the unrolling of loop “1” is applied to the first and second loops. Similarly, in the second trial, the unrolling of loop “2” is applied to the first and second loops and in the third trial the unrolling of loop 4 is applied to the first and second loops.

The array is prepared by reading in the line information of the execution time information files “F1.copt”, “F2.copt” and “F3.copt” by the optimum option decision unit 108 of FIG. 1.

FIG. 15F shows an example of an optimum option information array “Result”. Suffixes “1” and “2” of the array represent the consecutive number for the line information and elements of the array are the line numbers for the option designation loop and the optimum options.

In the array, the optimum option decision unit 108 of FIG. 1 obtains the file number having the minimum execution time of the execution times obtained from different files for each line number of the execution time array “Time”. The “F1.copt” is the optimum option for the line number “L1” and the “F3.copt” is the optimum option for the line number “L2”. Accordingly, the optimum option for the line number “L1” is the unrolling of loop “1” and the optimum option for the line number “L2” is the unrolling of loop “4”.

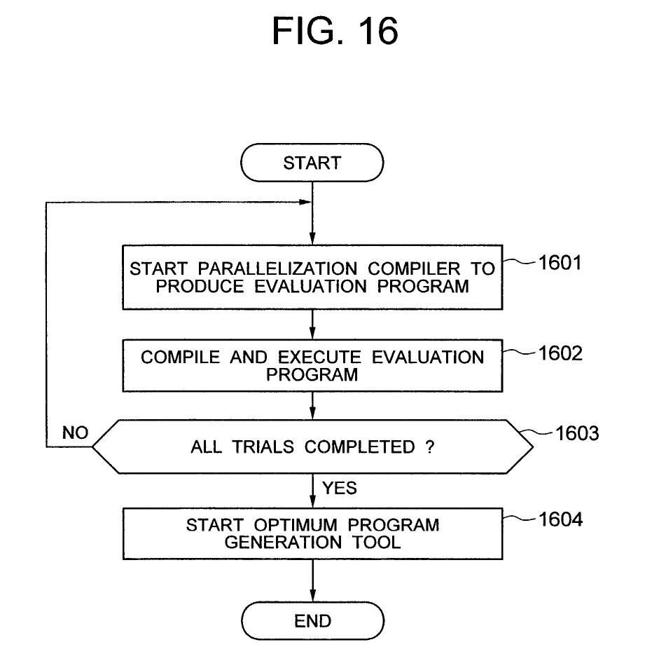

FIG. 16 is a flowchart showing an example of operation of the control program 100 shown in FIG. 1.

The control program 100 of FIG. 1 is to control processing operation of the whole system and starts the parallelization compiler 101 to produce the evaluation program 124 for the option information file 123 (step 1601). The control program 100 repeats compiling and execution (step 1602) of the produced evaluation program 124 by the number of all the option information files 123 (step 1603). Thereafter, the control program 100 starts the optimization program generation tool 107 (step 1604) to produce the program 128 with compiler directives.

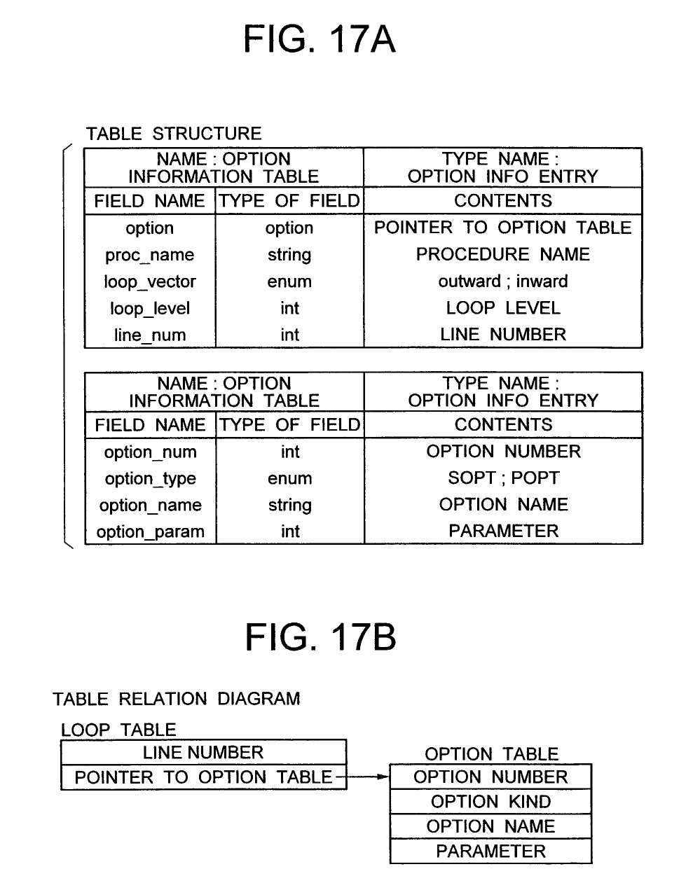

FIGS. 17A to 17B are diagrams explaining structure examples of the option information table 131 of FIG. 1.

FIG. 17A shows a table structure and FIG. 17B shows the relation of tables. As shown in the table structure of FIG. 17A, the option table is prepared by reading in the option information file 123 by the option information acquisition unit 104 of the evaluation program generation unit 103 provided in the parallelization compiler 101 and converting it into the internal expression in the compiler.

As shown in the table relation diagram of FIG. 17B, the option table is indicated from the loop table in the compiler for each loop designated by the option.

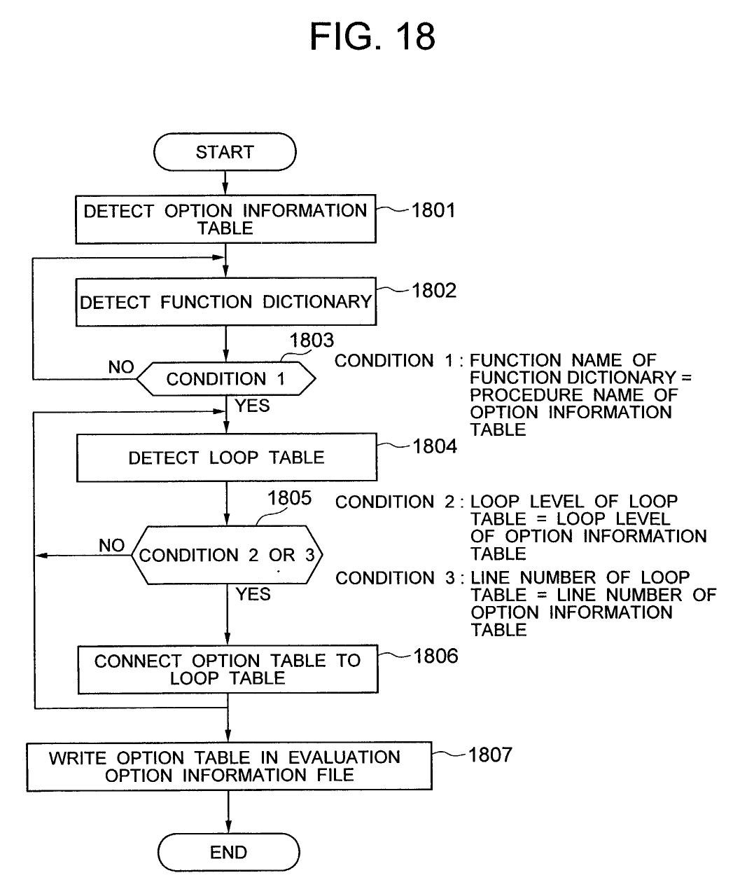

FIG. 18 is a flowchart showing an example of processing operation of the option information acquisition unit 104 shown in FIG. 1.

The option information acquisition unit 104 detects a coincident function dictionary for each option information table (steps 1801 to 1803). Further, the option information acquisition unit 104 detects the loop table having the coincident loop level or line number and connects the option table to the loop table (step 1806). Finally, contents of the option table is written in the evaluation option information file (step 1807).

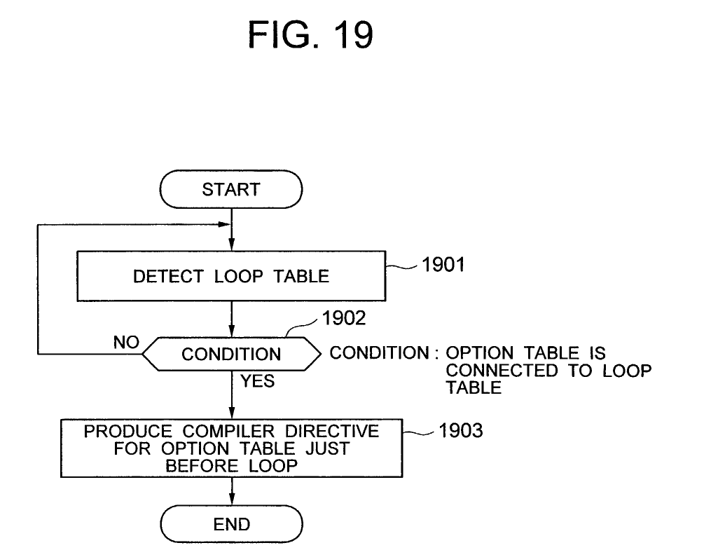

FIG. 19 is a flowchart showing an example of processing operation of the compiler directive generation unit shown in FIG. 1.

This example shows generation processing contents of the evaluation program 124 of the compiler directive generation unit 105. If the compiler directive generation unit 105 detects that the option table is connected to the loop table (steps 1901 and 1902), the unit 105 produces the compiler directive for the option table just before the loop sentence (step 1903).

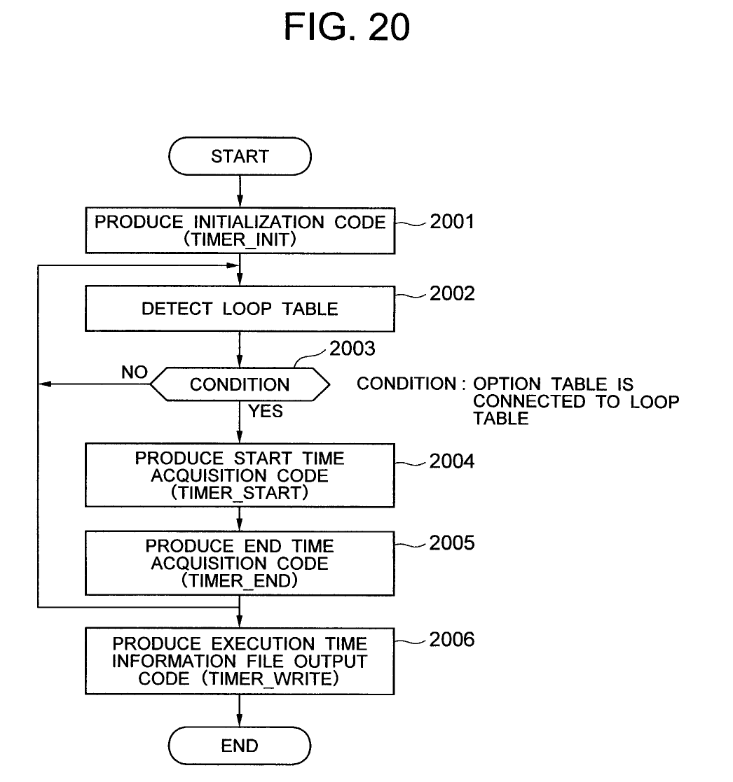

FIG. 20 is a flowchart showing an example of processing operation of the execution time acquisition code generation unit 106 shown in FIG. 1.

The execution time acquisition code generation unit 106 performs generation of the initialization code (timer_init) (step 2001), detection of the loop table connected to the option table (steps 2002 and 2003), generation of the start time acquisition code (timer_start) (step 2004), generation of the loop end time acquisition code (timer_end) (step 2005) and generation of the output code (timer_write) of the execution time information file of the loop (step 2006).

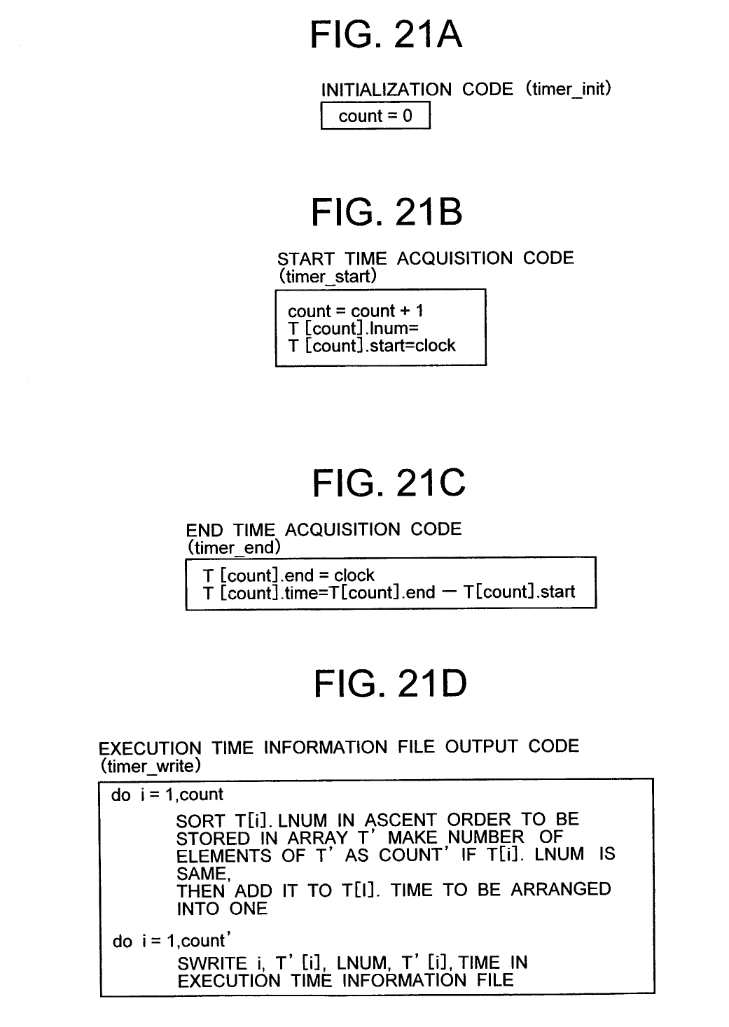

FIGS. 21A to 21D are diagrams explaining structure examples of the execution time acquisition codes produced by the execution time acquisition code generation unit 106 shown in FIG. 1.

FIG. 21A shows a structure example of the initialization code (timer_init), which is a code for initializing the counter for causing the start time to correspond to the end time for each loop when the designated loop is repeated many times upon execution of the program.

FIG. 21B shows a structure example of the initialization time acquisition code (timer_start), which is a code for incrementing the counter at the entrance of the loop and storing the line number and the start time in the array T.

FIG. 21C shows a structure example of the end time acquisition code (timer end), which is a code for calculating a loop end time of the array T and a loop execution time obtained by subtracting a loop start time from the loop end time at the exit of the loop and storing the loop execution time in the array T.

FIG. 21D shows a structure example of the loop execution time information file output code (timer_write), which is a code for sorting the loop line number for the array T in order of ascent at the last of the program to be stored in array T′, storing the number of elements of the array T′ in count′ and writing the array T′ in the execution time information file 127.

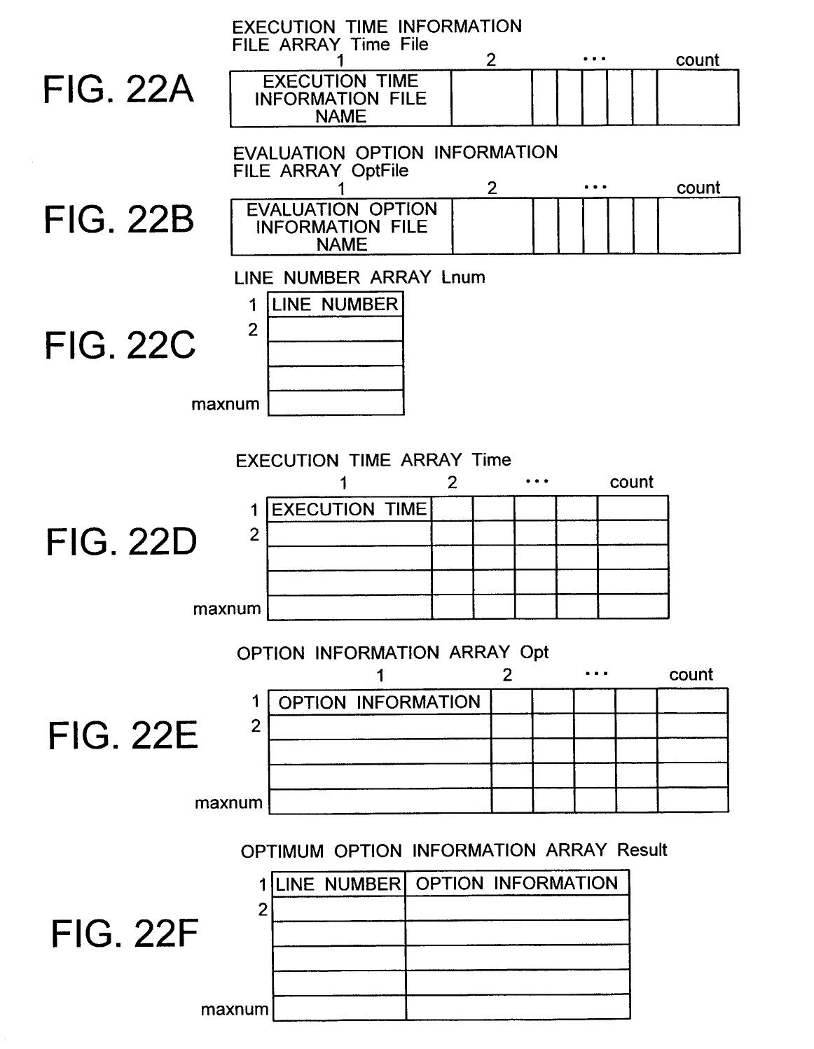

FIGS. 22A to 22F are diagrams explaining structure examples of information arrays upon data processing of the optimum option decision unit shown in FIG. 1.

FIG. 22A shows a structure of the execution time information file array (TimeFile) which is an internal expression into which the execution time information generalization file 126 is converted. The execution time information file array (TimeFile) includes suffixes representing the time of trial and elements representing execution time information file names.

FIG. 22B shows a structure of the evaluation option information file array (OptFile) which is an internal expression into which the execution time information generalization file 126 is converted. The evaluation option information file array (OptFile) includes suffixes representing the time of trial and elements representing evaluation option information file names.

FIG. 22C shows a structure of the line number array (Lnum) which is an internal expression into which the execution time information file 127 and the evaluation option information file 128 are converted. The line number array (Lnum) includes suffixes representing the consecutive numbers for the line information in the execution time information file 127 and the evaluation option information file 128 and elements representing the line numbers for the line information.

FIG. 22D shows a structure of the execution time array (Time) which is an internal expression into which the execution time information generalization file 126 and the execution time information file 127 are converted. The execution time array (Time) is a two-dimensional array and includes first suffixes (row direction) representing the consecutive numbers for the line information of the execution time information file 127, second suffixes (column direction) representing the time of trial of the loop execution time information generalization file 126 and elements representing the execution times for the line information of the execution time information file 127.

FIG. 22E shows a structure of the option information array (Opt) which is an internal expression in which the execution time information generalization file 126 and the evaluation option information file 128 are converted. The option information array (Opt) is a two-dimensional array and includes first suffixes (row direction) representing the consecutive numbers for the line information of the evaluation option information file 128, second suffixes (column direction) representing the time of trial of the execution time information generalization file 126 and elements representing the option information of the evaluation option information file 128.

FIG. 22F shows a structure of the optimum option information array (Result). The optimum option information array (Result) is a one-dimensional array and includes suffixes representing the consecutive numbers for the line information similarly to the line number array and elements containing the line number and the option information.

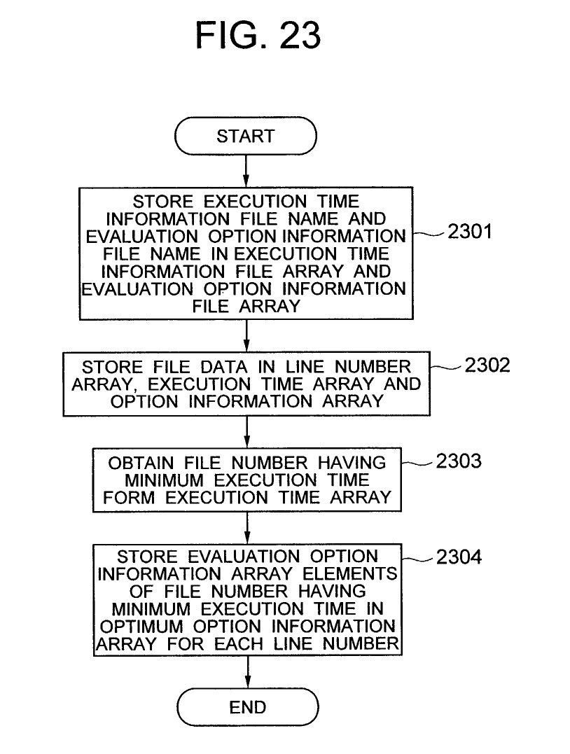

FIG. 23 is a flowchart showing an example of processing operation of the optimum option decision unit 108 shown in FIG. 1.

The optimum option decision unit 108 of FIG. 1 first stores the execution time information file name and the evaluation option information file name in the execution time array and the option information array (step 2301). The optimum option decision unit 108 stores data of the execution time information file and the evaluation option information file in the line number array, the execution time array and the option information array (step 2302).

Further, the optimum option decision unit 108 obtains the file number having the minimum execution time from the execution time array elements including different files for each line number of the execution time array (step 2303) and stores the evaluation option information array elements of the file number having the minimum execution time in the optimum option information array for each line number (step 2304).

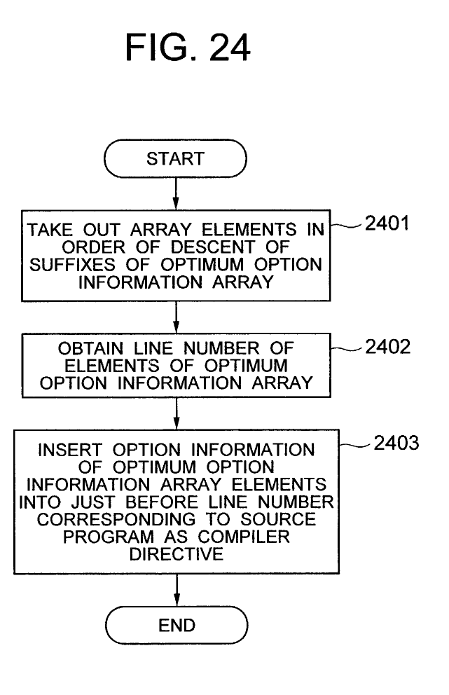

FIG. 24 is a flowchart showing an example of processing operation of the compiler directive insertion unit 109 of the optimum program generation tool 107 shown in FIG. 1.

The compiler directive insertion unit 109 of FIG. 1 takes out array elements in order of descent of the suffixes of the optimum option information array (step 2401) and then obtains the line number of the elements of the optimum option information array (step 2402). The compiler directive insertion unit 109 inserts the option information of the optimum option information array into just before the line number corresponding to the source program as the compiler directive (step 2403).

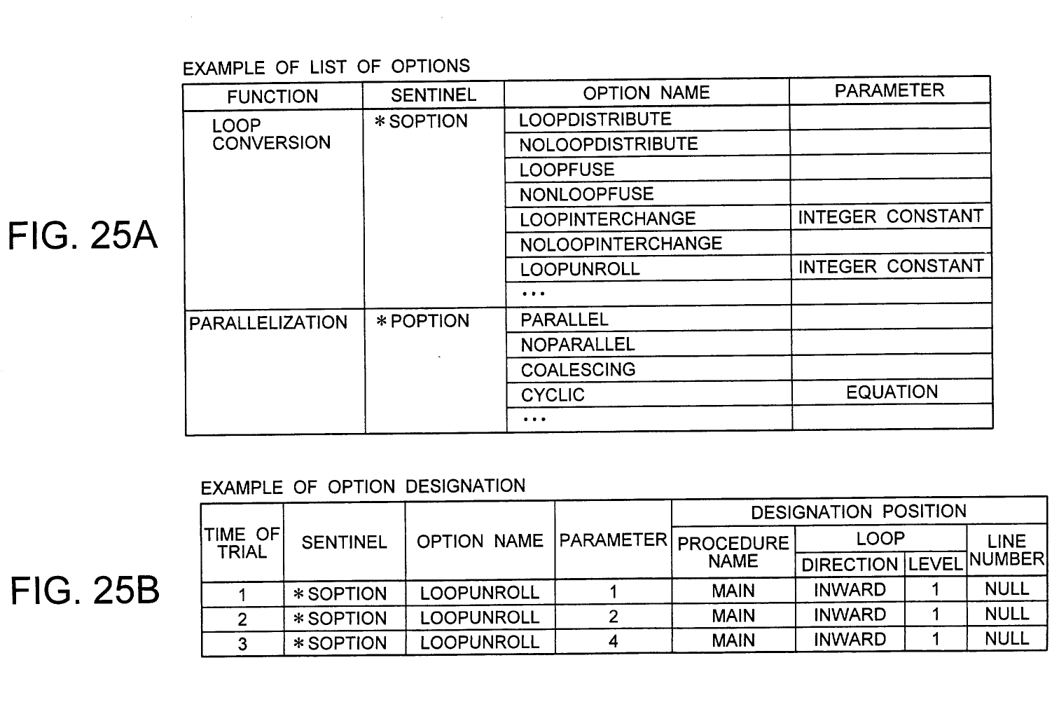

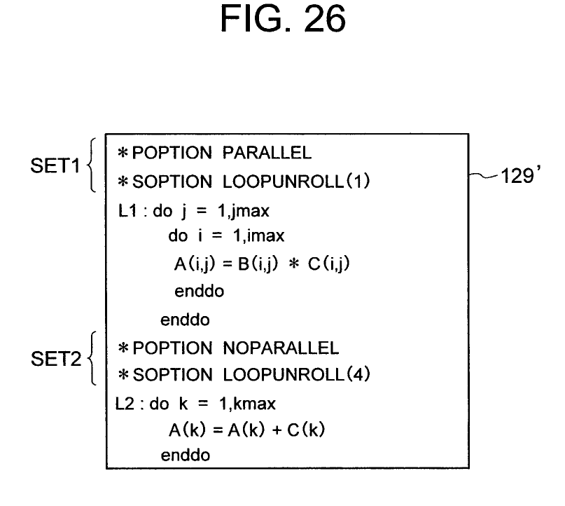

FIGS. 25A and 25B are diagrams explaining structure examples of user interfaces in the option designation unit 110 of FIG. 1.

FIG. 25A shows an example of a list of options which the user can designate. The options are classified into loop conversion options and parallelization options functionally. “*SOPTION” is used as the sentinel for the loop conversion options and “*POPTION” is used as the sentinel for the parallelization options.

The loop conversion options include loop distribution “LOOPDISTRIBUTE”, loop fusion “LOOPFUSE”, loop interchange “LOOPINTERCHANGE”, unrolling of loop “LOOPUNROLL” and the like.

The parallelization options include loop parallelization “PARALLEL”, loop single “COALESCING”, loop cyclic division “CYCLIC” and the like. Parameters can be designated for the loop conversion, the unrolling of loop and the loop cyclic division.

FIG. 25B shows an example of an option designation pictures on the output unit 111 provided to the user. The user designates three ways of options by means of the input unit 112. In FIG. 25B, there is shown that the number of unrolling operations “1”, “2” and “4” for the unrolling of loop are applied to the outermost loop of the procedure MAIN.

As described above with reference to FIGS. 1 to 25, the embodiment comprises the evaluation program generation unit 103 for applying the compile option from the plurality of compile options (compiler directives) to the computer program (source program 120) including the loop processing one by one (compile option information acquisition unit 104), inserting the compile option (compiler directive) into just before each loop (compiler directive generation unit 105) and producing the code for measuring the execution time of each loop (loop execution time acquisition code generation unit 106) to prepare the evaluation program 124, the compile and execution unit 1404 for compiling and executing the evaluation program 124 to measure the execution time of each loop and storing it as the execution time information group 125, the optimum compile option decision unit 108 for detecting the compile option (compiler directive) with which the execution time is shortest for each loop on the basis of the measured result, and the compiler directive insertion unit 109 for producing the program (program 129 with compiler directives) in which the compile option (compiler directive) is inserted into just before each loop.

The present invention is not limited to the embodiment explained with reference to FIGS. 1 to 25 and various changes and modifications may be made in the invention without departing from the spirit and the scope thereof. For example, application of a combination of a plurality of compile options, application of the compiler directives to a partial loop in the evaluation program, application of different compiler directives to individual loops of the evaluation program or the like can be made. FIG. 26 shows an example in which sets of compiler directives are inserted into just before each program portion. In FIG. 26, “*POPTION PARALLEL” and “*SOPTION LOOPUNROLL(1)” are inserted as a set SET1 of compiler directives and “*POPTION NOPARALLEL” and “*SOPTION LOOPUNROLL(4)” are inserted as a set SET2 of compiler directives into program 129′.

Further, FD (flexible disk) or the like may be used as media for recording programs of the embodiment. Moreover, programs may be downloaded through a network by means of a communication apparatus to be installed.

Furthermore, in the embodiment, the loop processing and the parallelization have been described as program portions to be optimized, while the present invention is not limited thereto.

With the above configuration and processing operation, in the embodiment, the compiler directive can be detected for each program portion and the execution speed of the whole program can be improved. Further, user's time and labor for inserting the compiler directive with parameter can be removed and user's burden required for optimization of programs can be reduced. In addition, the number of times of trials for detecting a compiler directive for each program portion can be reduced.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A system for tuning a computer program including program portions to be converted by compiler directives, comprising:
means for taking out one from a plurality of compiler directives to insert it into just before each program portion and inserting a code for measuring an execution time of each program portion in which said compiler directive is inserted to produce an evaluation program;
compile and execution means for compiling said evaluation program and executing it;
means for measuring the execution time of each program portion in said evaluation program and storing it in a memory unit;
means for detecting a compiler directive having a shortest execution time of the program portion for each program portion on a basis of measured results of the execution time of each program portion after generation and execution of said evaluation program are repeated by a number of the plurality of compiler directives; and
means for inserting each of said detected compiler directives into just before a relevant program portion to produce a program with compiler directives.

2. A tuning method of a computer program including program portions to be converted by compiler directives, comprising:
applying a compiler directive to each program portion and executing each program portion for each of a plurality of compiler directives;
measuring an execution time of each program portion for each compiler directive;
detecting a compiler directive having a shortest execution time for each program portion on a basis of measured results; and
inserting each of said detected compiler directives into just before a relevant program portion to produce a program.

3. A tuning method of a computer program including program portions to be converted by compiler directives, comprising:
applying a set of compiler directives to each program portion and executing each program portion for each of sets of compiler directives;
measuring an execution time of each program portion for each set of compiler directives;
detecting a set of compiler directives having a shortest execution time for each program portion on a basis of measured results; and
inserting each of said detected sets of compiler directives into just before a relevant program portion to produce a program.

4. A program tuning method according to claim 2, wherein
said compiler directive is a compiler directive with performance parameter, and application and execution of each compiler directive for each program portion are made by a number of kinds of the compiler directives and the performance parameters.

5. A program tuning method according to claim 3, wherein
said compiler directive is a compiler directive with performance parameter and the application and execution of each compiler directive for each program portion are made by a number of kinds of the compiler directives and sets of performance parameters.

6. A program stored in a computer readable recording medium for tuning a computer program including program portions to be converted by compiler directives, comprising:
applying a compiler directive to each program portion and executing each program portion for each of a plurality of compiler directives;
measuring an execution time of each program portion for each compiler directive;
detecting a compiler directive having a shortest execution time for each program portion on a basis of measured results; and
inserting each of said detected compiler directives into just before a relevant program portion to produce a program.

7. A program stored in a computer readable recording medium for tuning a computer program including program portions to be converted by compiler directives, comprising:
applying a set of compiler directives to each program portion and executing each program portion for each of sets of compiler directives;
measuring an execution time of each program portion for each set of compiler directives;
detecting a set of compiler directives having a shortest execution time for each program portion on a basis of measured results; and
inserting each of said detected sets of compiler directives into just before a relevant program portion to produce a program.

8. A computer readable recording medium in which a program for executing a method of tuning a computer program including program portions to be converted by compiler directives is stored, said program comprising:
applying a compiler directive to each program portion and executing each program portion for each of a plurality of compiler directives;
measuring an execution time of each program portion for each compiler directive;
detecting a compiler directive having a shortest execution time for each program portion on a basis of measured results; and
inserting each of said detected compiler directives into just before a relevant program portion to produce a program.

9. A computer readable recording medium in which a program for executing a method of tuning a computer program including program portions to be converted by compiler directives is stored, said program comprising:
applying a set of compiler directives to each program portion and executing each program portion;
measuring an execution time of each program portion for each set of compiler directives;
detecting a set of compiler directives having a shortest execution time for each program portion on a basis of measured results; and
inserting each of said detected sets of compiler directives into just before a relevant program portion to produce a program.
